(19) United States
(12) Patent Application Publication
(10) Pub. No.: US 2011/0165293 A1
(43) Pub. Date: Jul. 7, 2011

(54) CONFECTIONERY PRODUCT

(76) Inventors: Ingrid Willibald-Ettle, Landau (DE); Margit Arenz, Nehren (DE); Veerle De Bondt, Jodoigne-Souveraine (BE)

(21) Appl. No.: 13/062,924

(22) PCT Filed: Sep. 14, 2009
(86) PCT No.: PCT/EP2009/006639

§ 371 Date: Mar. 8, 2011

Related U.S. Application Data
(60) Provisional application No. 61/097,985, filed on Sep. 18, 2008.

(30) Foreign Application Priority Data
Sep. 16, 2008 (EP) 08016252

(51) Int. Cl. A23G 3/54; A23L 1/00

(52) U.S. Cl. 426/103; 426/289

(57) ABSTRACT

The invention relates to a confectionery product having a core and a shell, whereby at least the shell is not fat-continuous, said confectionery product containing between 10 and 55 wt. % of fructan and at most 70 wt. % of sucrose. The shell represents between 10 and 90 wt. % of the confectionery product as a whole. The confectionery product preferably has a non-sucrose bulk sweetener such as Isomalt as main component. The invention further relates to a process for preparing a confectionery product, in particular a filled hard candy.

The invention relates to a confectionery product.

Confectionery products like hard candies, soft chews, chewing gums etc. are as such well-known.

Although originally not having a reputation of being healthy, in particular due to the high amount of sucrose and/or glucose contained in them, some of the confectionery products have over the years structurally changed their composition and image. For example, the partial or even total replacement of sucrose and glucose by bulk sweeteners like maltitol, Isomalt and xylitol contributed to this development.

Nevertheless, there is a continuing need for the provision of confectionery products providing further health benefits; this need represents the objective of the present invention.

The objective is achieved in that the confectionery product comprises a core and a shell, whereby:
the confectionery product as a whole contains between 10 and 55 wt. % of fructan and at most 70 wt. % of sucrose;
the shell is not fat-continuous;
the shell represents between 5 and 95 wt. % of the confectionery product as a whole.

As is as such known, fructans are prebiotic ingredients. An advantage of the confectionery products according to the invention is that they can not only provide health benefits such as for example a reduced sucrose content, tooth-friendliness and reduced glycemic response, but can additionally provide a prebiotic effect.

Patent application GB-A-2 430 344 discloses confectioneries comprising a non-digestible oligosaccharide or polysaccharide.

WO-A-93/02566 relates to a reduced calorie chocolate confectionery composition in which the sugar is wholly or partially replaced by a product selected from the group consisting of inulin, branched inulin, linear fructo-oligosaccharides, branched fructo-oligosaccharides or a mixture thereof, with possibly a high-intensity sweetener.

US-A-2004/086615 relates to a confectionery composition that has a relatively low caloric content and includes erythritol and an fructo-oligosaccharide component. The composition may also include isomalt, polydextrose and/or a high protein material. The composition generally contains very low levels of sugars, such as sucrose, and preferably is substantially free of sugars altogether. The composition typically includes a sufficient amount of fructo-oligosaccharide (“FOS”) and/or other components to substantially neutralize the cooling effect of erythritol present.

The invention relates to confectionery products. As is known, confectionery products are products having a bulk sweetener such as sugar as a principal component, often combined with colouring matter and flavouring and often with fruit or nuts. Confectionery products are often also referred to as candies, sweets or boiled sweets. Examples of such products in general are: chewing gum (filled or non-filled), hard candy (also referred to as hard caramel), soft candy (also referred to as soft caramel), toffee, pastille, gum, jelly, marshmallow, nougat, lozenge, fudge, or chocolates.

In a preferred embodiment of the invention, the confectionery product is chosen from the group consisting of hard candies, soft candies, and toffees. More preferably, the confectionery product is a filled hard candy.

According to the invention, the confectionery product comprises a core and a shell. These products are as such known; examples thereof are filled hard candies or filled soft candies. As is also known, the weight ratio between core and shell can vary between wide ranges. It is not uncommon that the core represents about 5 to 10 wt. % of the total weight of the confectionery product, but on the other hand the core may also represent up to 90 or 95 wt. % of the total weight of the confectionery product. Thus, the shell too may represent between 5 or 10 and 90 or 95 wt. % of the confectionery product as a whole. It is noted hereby that the term shell as used herein is meant to indicate that this portion of the confectionery product is more substantial than a mere coating, as a coating typically represents less than 1 wt. % of the product as whole to which the coating is applied to. In one embodiment of the invention, a coating is applied to the shell. Preferably, the shell represents between 15 and 85, between 20 and 80, between 25 and 75, between 30 and 70, or between 35 and 65 wt. % of the total weight of the confectionery product.

According to the invention, the confectionery product contains between 10 and 55 wt. % of fructan. The term fructan as used herein has its common meaning of being a generic term that relates to a—usually polydisperse—carbohydrate material consisting mainly of fructosyl-fructose links with optionally a glucose starting moiety. The meaning of fructan encompasses the more specific compounds inulin—wherein the fructosyl-fructose links are mainly of the β(2→1) type—and levan—wherein the fructosyl-fructose links are mainly of the β(2→6) type.

As used herein, the meaning of the term inulin encompasses also the compounds known as oligofructoses; typical of oligofructoses is that they are inulins whereby the degree of polymerisation (DP) ranges from 2 to 10. In practice, oligofructose compounds are also referred to as fructooligosaccharide; as meant herein, these terms are considered to be synonyms.

Preferably, the fructan in the invention contains inulin or even consists essentially only of inulin. The inulin can be an oligofructose, or inulin having a number-average degree of polymerisation ( D̅P̅) above 10, e.g. between 10 and 30. The inulin can also be a mixture of easily fermentable inulin compounds and inulin compounds that ferment more slowly, as disclosed in for example WO-A-01 60176.

The total amount of fructan in the confectionery product according to the invention should be at least 10 or 15 wt. %, relative to the confectionery product as a whole. This has the advantage that a prebiotic effect—i.e. a measurable effect resulting from the consumption of a prebiotic ingredient—may be reached while consuming only a limited number of confectionery products. In the case of fructans such as inulin, it is generally acknowledged that a prebiotic effect is established with a daily consumption of 5 to 8 grams or more.

In further preferred embodiments, the amount of fructan in the confectionery product as a whole is chosen at a value of at least 20 wt. % or 25 wt. %.

The term prebiotic ingredient as used herein relates to ingredients that fulfil the criteria of non-digestibility, fermentability and selective stimulating capacity. Non-digestible food ingredients are those that are resistant to gastric acidity, hydrolysis by intestinal brush border/pancreatic digestive enzymes, and gastrointestinal absorption. Fermentable food ingredients are those that are fermented by the intestinal, mainly colonic, microflora. The ingredient is said to have selective stimulating capacity if it stimulates selectively the growth and/or metabolic activity of those intestinal bacteria that are associated with health and well-being, such as bifidobacteria. Fructans, in particular inulins, are widely considered to be prebiotic ingredients based on convincing evidence obtained in multiple human studies.

The total amount of fructan in the confectionery product according to the invention should be chosen below a value of 55 wt. %, relative to the confectionery product as a whole. This has the advantage that a confectionery product having multiple desirable properties may be provided by the other ingredients making up the confectionery product. In further preferred embodiments, the amount of fructan in the confectionery product as a whole is chosen at a value of at most 50 wt. %, 45 wt. %, 40 wt. % or 35 wt. %.

The confectionery product according to the invention as a whole should contain at most 70% of sucrose. This has the advantage that compared to those confectionery products that consist almost entirely of sucrose, the confectionery product according to the invention can classify as being reduced in sugar. In a preferred embodiment, the the confectionary product as a whole has a reduced sucrose content as meant in EC Regulation 1924/2006. As is known, Article 8(1) of Regulation 1924/2006 in combination with the Annex to the Regulation defines that characterisations on a reduced amount of a nutrient, such as the characterisation ‘Reduced Sucrose’, may be allowed as a nutritional claim if the reduction in content is at least 30% compared to a similar product. As is known, further details on the interpretation on the comparison to a similar product are given in the Guidance on the implementation of Regulation No 1924/2006 (version 14.12.2007, published by the European Commission), in particular in Chapter 11.2 titled “Guidance for the use of comparative claims”.

In further preferred embodiments of the invention, the confectionery product as a whole contains at most 60, 50, 40, 30, 25, 20, 15, or even at most 10 wt. % sucrose.

In yet a further preferred embodiment, the confectionery product according to the invention contains at most 60, 50, 40, 30, 25, 20, 15, 10 or even 5 wt. %, relative to the confectionery product as a whole, of compounds from the group consisting of fructose, glucose and sucrose. The presence of only low amounts of these compounds has the advantage that it can qualify as being low in sugar, thereby avoiding any negative health aspects associated with confectionery products having significant amounts of fructose, glucose, and/or sucrose. In further preferred embodiments, the amount of compounds from the group consisting of fructose, glucose and sucrose in the confectionery product as a whole is chosen at a value of at most 4 wt. %, 3 wt. %, 2 wt. %, or 1 wt. %. Most preferably, the amount of compounds from the group consisting of fructose, glucose and sucrose in the confectionery product as a whole is chosen at a value of at most 0.5 wt. % or 0.4 wt. %; this has the advantage that the confectionery product can qualify as being sugar-free.

It is in particularly preferred that the upper limits as given for the amount of compounds chosen from the group consisting of fructose, glucose and sucrose in the confectionery product of the invention are also valid for the amount of compounds chosen from the group consisting of fructose, glucose, sucrose, maltose and lactose.

In the confectionery product of the invention, the shell is not fat-continuous, i.e. does not have a fat-continuous phase. An example of a product having a fat-continuous phase is chocolate. An example of a non fat-continuous phase is a product wherein the continuous phase consists essentially of the non-sucrose bulk sweetener Isomalt. In a preferred embodiment, neither the shell nor the core are fat-continuous.

According to a preferred embodiment of the invention, the core of the confectionery product contains an inulin composition and at most 15 wt. % of compounds from the group consisting of fructose, glucose and sucrose. As meant herein, the term inulin composition means a composition that contains inulin but may also contain other compounds. Examples of other compounds are processing aids, viscosity modifiers, colouring compounds, and flavours. The inulin composition may be present in any suitable physical form such as solid, dispersion or liquid form.

In a preferred embodiment of the invention, the amount of inulin in the core of the confectionery product is at least 25 wt. % of the total amount of inulin in the confectionery product. More preferably, the amount of inulin in the core of the confectionery product is at least 30, 35, 40, 45, 50, 55, or at least 60 wt. % or even essentially all of the total amount of inulin in the confectionery product. Inulin can in these preferred embodiments be the main component of the core.

It may well be preferred that not only the core but also the shell of the confectionery product according to the invention contains a fructan, such as inulin. This has the advantage that a higher portion of the fructan may be delivered to the consumer per confectionery product, so that already a small number of consumed confectionery products will provide a prebiotic effect. In one embodiment of the invention, the consumption of one confectionery product provides a significant contribution to achieving a prebiotic effect. As meant herein, a significant contribution to achieving a prebiotic effect means that at least 10 wt. %, preferably at least 12.5 wt. % of the minimum amount (daily dose) for achieving a prebiotic effect is contained in one confectionery product. In the case of inulin, studies indicate that a daily dose of 5 to 8 grams is capable of achieving a prebiotic effect. It is preferred that a confectionery product according to the invention supplies at least 0.5, 0.6 or 0.75 gram of fructan, preferably inulin. More preferably, a confectionery product according to the invention provides between 0.80 and 2.0 grams of inulin, in particular between 1.0 and 1.75 grams of inulin.

According to a particularly preferred embodiment of the invention, the confectionery product is a filled hard candy whereby the continuous phase of the shell essentially consists of a non-sucrose bulk sweetener such as maltitol, sorbitol, xylitol, mannitol, polydextrose, isomaltulose or mixtures of 6-0-α-D-glucopyranosyl-D-sorbitol (1,6-GPS) and 1-0-α-D-glucopyranosyl-D-mannitol (1,1-GPM) such as Isomalt®. Most preferably, the shell of the hard candy has Isomalt as main component; Isomalt is in particular suitable due to its low hygroscopy. Preferably, such confectioneries contain essentially no fat or proteins.

The confectionery product according to the invention may be prepared by using confectionery-preparing processes that are as such known to the person skilled in the art. It is noted hereby that the skilled person may need to take certain characteristics of the compounds involved into account. In particular, measures should be taken in order to ensure that the fructan to be incorporated into the confectionery product does not suffer too much from depolymerisation (hydrolysis), since the depolymerisation of fructans can lead to the release of fructose and possibly glucose or sucrose, compounds that should be present in only a limited amount in the finished confectionery product. Some examples of measures that can be taken during the preparation of a confectionery product according to the invention are:
Control of temperature, in particular when the temperature of the fructan during preparation is planned to be raised to a value higher than 100° C. Care should be taken to avoid overheating; for example, a temperature of 130° C. is preferred over a perhaps originally planned temperature of 160° C.
Control of pH, whereby a highly acidic environment should be avoided; for example, a pH of 5 is preferred over a pH of 3. An example of a measure that can be taken is to reduce or even avoid completely acidic ingredients like for example citric acid.

Another aspect of fructans that may need to be taken into account is their hygroscopic nature; it may thus be favourable to ensure, both during and after preparation, that the water content of the finished product is low, e.g. below 10, 5, 3 or even below 2 wt. %. This may be achieved by measures that are as such known, such as vacuum evaporation during preparation and/or by using a packaging of the finished confectionery product that is a barrier against moisture. It was found that in this way certain side effects may also be avoided, such as (re-)crystallisation of the bulk nutritional sweetener and the accompanying loss of gloss and visual attractiveness of the confectionery product.

The invention further relates to a process for the preparation of a filled confectionery product according to the invention comprising the steps of:
providing a core material and a shell material;
forming a shell;
introducing the core material into the shell;
closing the shell,

wherein the shell material is not fat-continuous, wherein the shell material and the core material combined contain between 10 and 55 wt. % of fructan and at most 70 wt. % sucrose, and wherein the weight ratio between shell material and core material in the resulting filled confectionery product lies between 5:95 and 95:5. Preferably, the core material contains fructan and at most 15 wt. % of compounds from the group consisting of fructose, glucose and sucrose. Preferably, both the core material and the shell material contain fructan, such that the confectionery product as a whole contains between 0.5 gram and 2 grams of fructan, said amount of fructan being between 10 and 55 wt. % of the confectionery product as a whole.

The shell material may be provided in a fashion that is known per se, such as by dissolving a bulk sweetener in an aqueous medium to form a solution, boiling—possibly under vacuum—the solution to evaporate most of the aqueous medium to form a highly viscous shell material mass, cooling the shell material mass, followed by adding to the cooled shell material mass any desirable ingredients/additives and distributing them over the shell material mass.

The preparation of the core material can often simply comprise the step of combining and mixing the desired ingredients, possibly combined with the addition of an aqueous medium, optionally followed by a heating step so as to enable transport of the core material.

The shell material and the core material may then be combined with each other to form a confectionery product such as a filled candy in a method that is as such known, such as for example the forming of an elongated extruded filled strand followed by moulding of individual candies from the filled strand.

The invention is elucidated by means of the following examples, without being limited thereto.

### EXAMPLE 1

A hard filled candy was prepared as described below. The material for forming the shell had the composition as given in Table 1:

TABLE 1

| Amount | Ingredient |
|---|---|
| 68.82 wt. % | Isomalt ® ST |
| 10.36 wt. % | Orafti ® L95 |
| 20.70 wt. % | Water |
| 0.10 wt. % | Caramel flavour |
| 0.02 wt. % | Sucralose |

Supplier of Orafti® L95 was BENEO-Orafti; supplier of Isomalt® ST was BENEO-Palatinit; the caramel flavour was Karamel flavour 1109607204 from Silesia. The material for forming the shell was prepared by placing water, isomalt and sucralose into a cooker at 27° C., followed by heating and cooking until the temperature had reached 160° C. Subsequently the Orafti®L95 was added while stopping the heat supply; the temperature dropped to 141° C. A vacuum (−0.9 bar) was applied for 3 minutes, and the flavour was stirred in manually. The cooked mass was taken out of the cooker and left to rest until it had cooled down to 72° C. Then the candy was produced using a standard candy-making machine, while being filled with the core material. The core material had the composition as given in Table 2.

TABLE 2

| Amount | | Ingredient |
|---|---|---|
| 67.7975 | wt. % | Orafti ® L95 |
| 9.00 | wt. % | Orafti ® P95 |
| 16.00 | wt. % | Orafti ® LGI |
| 3.00 | wt. % | Glycerol |
| 4.00 | wt. % | Sorbitol |
| 0.20 | wt. % | Menthol flavour |
| 0.0025 | wt. % | Colour (Black) |

The glycerol was supplied by Univar; the menthol flavour was Symrise 648398 natural Menthol flavour; the colour was Sensient Brilliant Black. The core material was prepared in a high-shear mixer by first putting the liquid ingredients in the mixer, followed by a pre-mix of the dry ingredients. This system was then mixed to dissolve the powders, while being heated to 60° C. At this temperature, the core material was fed to the candy-making machine.

Under these conditions the candy-making did not pose significant problems. The finished products weighed on average 4.0 grams, of which 15 wt. % was the core material and 85 wt. % the shell material. A determination of the content of fructose, glucose, sucrose, fructans and isomalt in the finished candies as a whole, thus averaging out the core and the shell, is given in Table 3. The solids content was determined to be 96.2%, the pH was 4.9.

TABLE 3

| Amount | |
|---|---|
| (wt. % on dry matter) | Ingredient |
| 1.51 | Fructose |
| 0.06 | Glucose |
| 0.12 | Sucrose |
| 16.0 | Fructans |
| 81.3 | Isomalt |

### EXAMPLE 2

Hard filled candies were prepared in the same fashion as in Example 1, with however the difference that the composition of the material for forming the shell was changed towards a higher fructan content—see Table 4.

TABLE 4

| Amount | Ingredient |
|---|---|
| 56.20 wt. % | Isomalt ® ST |
| 22.98 wt. % | Orafti ® L95 |
| 20.69 wt. % | Water |
| 0.10 wt. % | Caramel flavour |
| 0.02 wt. % | Sucralose |

As a consequence of the higher content of fructan in the shell material, the cooking procedure was changed somewhat: the initial cooking temperature was raised from 160 to 165° C., and subsequent to the adding of the fructan to the shell material the temperature (which had dropped more, to 124° C.) was raised to 132° C. and kept there for 6 minutes under vacuum.

The hard candies could be produced without significant difficulties and had an average weight of 4.0 grams, of which 19 wt. % was the core material and 81 wt. % the shell material. A determination of the content of fructose, glucose, sucrose, fructans and isomalt in the finished candies as a whole, thus averaging out the core and the shell, is given in Table 5. The solids content was determined to be 96.3%, the pH was 5.4.

TABLE 5

| Amount | |
|---|---|
| (wt. % on dry matter) | Ingredient |
| 2.27 | Fructose |
| 0.07 | Glucose |
| 0.15 | Sucrose |
| 24.5 | Fructans |
| 69.6 | Isomalt |

1. A confectionery product having a core and a shell, whereby:
the confectionery product as a whole contains between 10 and 55 wt. % of fructan;
the confectionery product as a whole contains at most 70% of sucrose;
the shell is not fat-continuous;
the shell represents between 5 and 95 wt. % of the confectionery product as a whole.

2. A confectionery product according to claim 1, wherein the confectionary product has a reduced sucrose content according to EC Regulation 1924/2006.

3. A confectionery product according to claim 1 containing at most 5 wt. % of a compound selected from the group consisting of fructose, glucose and sucrose.

4. A confectionery product according to claim 1, wherein the core contains an inulin composition and at most 15 wt. % of a compound selected from the group consisting of fructose, glucose and sucrose.

5. A confectionery product according to claim 1, wherein neither the core nor the shell are fat-continuous.

6. A confectionery product according to claim 1, wherein the confectionery product is a hard candy wherein the shell has Isomalt as a continuous phase.

7. A confectionery product according to claim 6, wherein the confectionery product is packaged in a packaging that forms a barrier against moisture.

8. A process for the preparation of a filled confectionery product, comprising the steps of
providing a core material and a shell material;
forming a shell;
introducing the core material into the shell;
closing the shell,
wherein the shell material is not fat-continuous, wherein the shell material and the core material combined contain between 10 and 55 wt. % of fructan and at most 70 wt. % sucrose, and wherein the weight ratio between shell material and core material in the resulting filled confectionery product lies between 5:95 and 95:5.

9. A process according to claim 8, wherein both the core material and the shell material contain fructan, such that the confectionery product as a whole contains between 0.5 gram and 2 grams of fructan, said amount of fructan being between 10 and 55 wt. % of the confectionery product as a whole.

10. A confectionery product according to claim 2 containing at most 5 wt. % of a compound selected from the group consisting of fructose, glucose and sucrose.

11. A confectionery product according to claim 2, wherein the core contains an inulin composition and at most 15 wt. % of a compound selected from the group consisting of fructose, glucose and sucrose.

12. A confectionery product according to claim 3, wherein the core contains an inulin composition and at most 15 wt. % of a compound selected from the group consisting of fructose, glucose and sucrose.

13. A confectionery product according to claim 2, wherein neither the core nor the shell are fat-continuous.

14. A confectionery product according to claim 3, wherein neither the core nor the shell are fat-continuous.

15. A confectionery product according to claim 4, wherein neither the core nor the shell are fat-continuous.

16. A confectionery product according to claim 2, wherein the confectionery product is a hard candy wherein the shell has Isomalt as a continuous phase.

17. A confectionery product according to claim 3, wherein the confectionery product is a hard candy wherein the shell has Isomalt as a continuous phase.

18. A confectionery product according to claim 4, wherein the confectionery product is a hard candy wherein the shell has Isomalt as a continuous phase.

19. A confectionery product according to claim 5, wherein the confectionery product is a hard candy wherein the shell has Isomalt as a continuous phase.
